(19) United States
(12) Patent Application Publication
(10) Pub. No.: US 2011/0208594 A1
(43) Pub. Date: Aug. 25, 2011

(54) Universal financial transaction system

(76) Inventor: Joshua A. Doro, Ft. Lauderdale, FL (US)

(21) Appl. No.: 12/387,579

(22) Filed: May 5, 2009

Related U.S. Application Data
(60) Provisional application No. 61/126,401, filed on May 5, 2008.

(51) Int. Cl. G06Q 30/00; G06Q 20/00; G06Q 40/00

(52) U.S. Cl. 705/14.69; 705/14.4; 705/39

(57) ABSTRACT

The Universal Financial Transaction System (UFTS) is an improved electronic payment system which uses encrypted software e to make financial transfers electronically. The UFTS operation is not limited to personal computers like the current online payment system. Moreover, it can be downloaded and operate on any electronic device such as mobile phones, PDA's, pocket computers, personal computer, electronic cash register or point of sale system. This improvement makes the UFTS as user friendly as any credit or debit card and as functional as any online banking system; thus it can be used to purchase items in any retail or online business and it can be used to transfer funds to any individual or entity among United States currency and any foreign currency. The UFTS does not charge the end-user for the financial transaction instead it generate its own revenue through transmittal of advertisement to the user's electronic device.

### RELATED APPLICATION

This application claims priority to provisional application No. 61/126,401, filed on May 5, 2009.

### BACKGROUND OF THE INVENTION

1. Field of the Invention

This invention relate to a system and methods for completing financial transaction using electronic devices including but not limited to computers, mobile phones and PDA's; and in particular to methods to make safe and secure financial transactions among any currency and from any source and location, all electronically

2. Description of Related Art

The current electronic payment systems are mostly online payment systems which allow individuals to make financial transactions electronically by using encrypted software. These funds can be used to pay for online auctions, online goods and services, make online donations or electronically send cash to someone. However, they don't allow individuals to purchase goods or services at retail stores because they can not be made to be used with mobile devices such as cellular phones, PDA's, mobile computers and etc.

In addition, the individual's funds reside in the online payment system's account until the holder of the funds makes a financial transaction. Thus the online payment system is the middleman of such financial transaction. While most online payment systems make their money by charging fees for each financial transaction for the account holder, some make money by collecting interest on the funds held in their account by the account holder. Moreover such prior art systems are subject to identity theft which can completely exhaust all money in the account. In this invention, the consumer places on those money that he expect to spend in the near future, which of course is the maximum he can loose.

When a merchant accepts a charge from a credit card or bank, the merchant pays interchange fee to the bank or credit card company. However, when a consumer uses an online payment system to perform such financial transfers, the online payment system pays said interchange fee and the online payment system is typically compensated by the fees they charge for the transfer. While some online payment systems are willing to make their services available for free, the most useful and reliable online payment systems are often not freely available.

The present invention improves the financial transaction system by (1) generating it own revenue through the fees charged when any audio or visual advertisement, coupon and/or other marketing material is sent to consumer operating device and (2) allowing financial transactions between virtually any electronic device; for example it can be used to purchase goods in retail stores, in doing so allows the consumer to avoid carrying the numerous credit and debit cards. In addition, it makes safe and secure financial transactions among any currency and from any source without cost to the end-user.

### SUMMARY OF THE INVENTION

The present invention is an improved financial transaction system which uses encrypted software to make financial transaction electronically utilizing portable electronically devices commonly carried on one person. The present invention's operation is not limited to personal computers or restricted to home computers like the current online payment system. Moreover, it can be downloaded and operate on any electronic device such as mobile phones, PDA's and mobile or pocket computer. This improvement makes the present invention as user friendly as any credit or debit card (but not subject to the extreme of credit card theft) and as functional as any online banking system; thus it can be used to purchase items in any retail or online business and it can be used to transfer funds to any individual or entity among United States and any foreign currency.

The present invention offers the functionality of any credit or debit card without the risk of a lost or stolen card, because it password protected; and encrypted software prevents interceptions and does not store any vital financial or consumer information on the operating device.

The present invention can generate its own revenue through sending electronic advertisement, coupons and/or marketing material for a fee to that of the advertiser. For example during or at any time before or after a financial transaction, an advertiser is charged a fee to send a visual or audio advertisement to consumer's operating device, which can be tailored to the vendor specific line of goods and/or the type of goods just purchased the consumer.

In accordance with the above, the present invention has been summarized to include the more important features so it may be better understood below in description of the preferred embodiment.

### BRIEF DESCRIPTION OF FIGURES

FIG. 1 is a block diagram illustrating an exemplary financial transaction that may be used in a point of sale or an online purchase system via any electronic device.

FIG. 2 is a block diagram illustrating an exemplary financial transaction that may be used to transfer funds to another person via any electronic device.

FIG. 3 is a flow diagram illustrating an exemplary process of a consumer or transferor creating account with the Universal Financial Transaction System and funding that account and then installing the application that interfaces with the UFTS on their electronic device.

FIG. 4 is a flow diagram illustrating an exemplary process of business, vendor or transferee creating an account with the Universal Financial Transaction System and then installing the application that interfaces with the UFTS on their electronic device.

FIG. 5 is a flow diagram illustrating an exemplary process of Universal Financial Transaction System performing financial transaction.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functioning details disclosed herein are not to be interpreted as limiting, but merely as a basis for the claims and as a representative basis for teaching one skilled in the art to variously employ the present invention in virtually any appropriately detailed structure.

Additionally, embodiments of the invention will now be described with reference to the accompanying Figures, wherein like numerals refer to like elements throughout. The terminology and verbiage used herein is intended to better enable a person to understand the invention and therefore, such verbiage is not intended to be interpreted in any limited or restrictive manner, simply because it is being utilized in conjunction with a detailed description of certain specific embodiment s of the invention. Furthermore, embodiments of the invention may include several novel features, no single one of which is solely responsible for its desirable attributes or which is essential to practicing the inventions herein described.

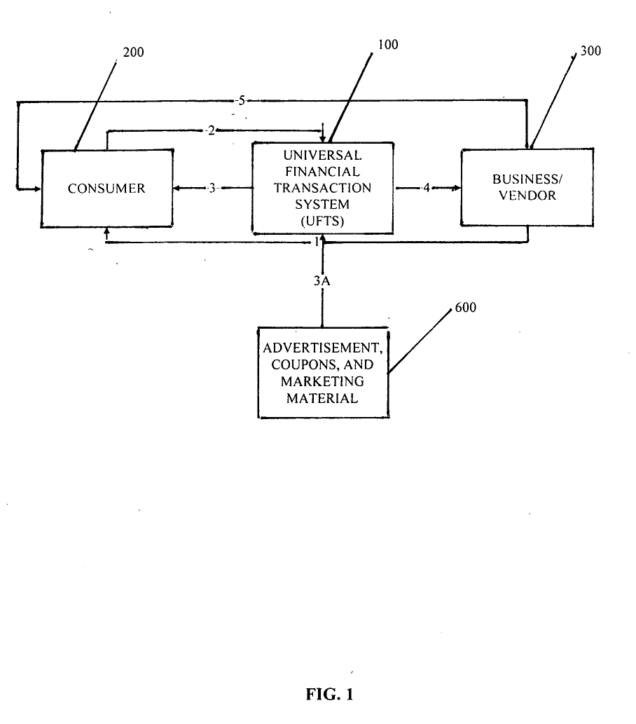

Reference is now made to the drawings accompanying this application. FIG. 1 is a block diagram illustrating an exemplary financial transaction that can be used in a point of sale or an online purchase system via any electronic device. The term “system”, as used herein, means, but is not limited to software or hardware component. The system can be stored on addressable storage medium, processors, hard drives or accessible memory. The system can include processes, functions, attributes, procedures, encrypted software and subroutines, segments of program code, drivers, modules, firmware, computer programs, source code, micro code, circuitry, data, databases, data structures, tables, arrays and variables. The term “business”, as used herein, means but is not limited to a retail store or vendor, online store or vendor and merchant.

As illustrated in FIG. 1, the Universal Financial Transaction System (UFTS) 100 communicates with business or vendor's electronic device 300 and consumer's electronic device 200. The consumer's electronic device 200 and the business or vendor's electronic device 300 contains an interface application which allows communication with the UFTS and allows communication with each other. FIG. 1 also includes numbered steps, signified by numbers in the arrows that illustrate the order of information flow in completing a typical financial transaction.

In operation, the business or vendor's electronic device 300 communicates with the consumer's electronic device 200 where the consumer is attempting purchase a product from business (step 1 of FIG. 1). The communication between the business's electronic device 300 and consumer's electronic device 200 is accomplished by any wireless communication system such as wireless internet, mobile communication system or networking, Bluetooth or Wi-Fi. Moreover the consumer need not be in the business place of business, for example the consumer can refer to a product or catalog number of a particular vendor from a remote location.

In one embodiment, the consumer enters a retail store to purchase a product. The consumer's electronic device 200 is a mobile phone, PDA or pocket computer. The business's electronic device 300 is a point of sale system or electronic cash register. The consumer brings the product to the cashier for purchase and the cashier scans the product or manually enters the product information. Then the cashier, via the application that interfaces with the UFTS 100 and the business's point of sale system or electronic cash register 300 wirelessly sends to the consumer's mobile phone, PDA or pocket computer 200 the product information and price, and business's deposit account information. The consumer receives the product information and price, and the business's deposit account information on the consumer's electronic device 200, via the application that interfaces with the UFTS.

Step 2 of FIG. 1, the consumer with their secure user identification and personal identity number (PIN) logins into the UFTS 100 via consumer's electronic device, then consumer electronic device 200 wirelessly transmits the product information and price, and business deposit information 230 to the UFTS 100, when the consumer elects to complete financial transaction. In one embodiment, the consumer using their mobile phone's 200 wireless network transmits the product information and price and business's deposit information 230 to the UFTS 100 to approve the purchase of the product. In another embodiment, the consumer using a PDA 200 or pocket computer 200 wirelessly transmits the product information and price and business's deposit account 230 information to the UFTS 100 to accept the purchase of the product.

Step 3 of FIG. 1, concurs simultaneous with step 2 of FIG. 1, where the UFTS 100 wirelessly transmits to the consumer's electronic device 200 advertisement, coupons and/or marketing material 600, then at the completion of the financial transaction in step 2 of FIG. 1, the UFTS 100 send a notice to the consumer electronic device 200 verifying the completion of the financial transaction. In one embodiment, the UFTS 100 wireless transmits the advertisement 400 to the consumer's mobile phone 300 for audio and/or visual viewing of cached, streaming video, SMS images and sounds or MMS images and sounds. Then the UFTS 100 sends a verification notice to the consumer's mobile phone 200. In another embodiment, the UFTS 100 wirelessly transmits coupons to the consumer's PDA Or pocket computer 200 for audio and/or visual viewing of cached, streaming video, SMS images and sounds or MMS images and sounds. Then the UFTS 100 sends a verification notice to the consumer's PDA or pocket computer 200.

Step 3A in FIG. 1, the advertiser electronically sends advertisements, coupons and/or marketing material to the UFTS 100 and the UFTS 100 charges the advertiser a fee for each advertisement, coupon or marketing material 600 sent to the consumer's electronic device 200.

Step 4 in FIG. 1, the UFTS 100 sends a verification notice to the business's electronic device 300 upon completion of the financial transaction described in step 2 in FIG. 1. In one embodiment, the UFTS 100 sends a notice verifying that the financial transaction, purchase of product, was successful, to the business' electronic cash register or point of sale system 300.

Step 5 in FIG. 1, the business's electronic device 300 sends receipt of the purchase of the product to the consumer's electronic device 200. In one embodiment, the business electronic cash register or point of sale system 300 wirelessly sends the consumer's mobile phone 200 a receipt of the purchased product. In another embodiment, the business electronic cash register or point of sale system 300 via Bluetooth, Wi-Fi or wireless internet sends a receipt to consumer's PDA or pocket computer 200. This advertisement 600 can be either cached, streamlined or SMS text to the Consumer's electronic device 200.

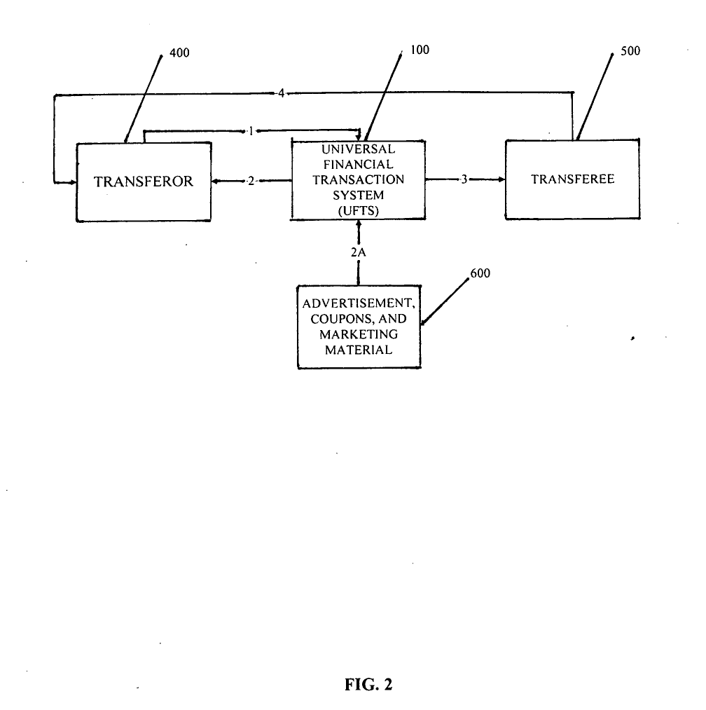

FIG. 2 is a block diagram illustrating an exemplary financial transaction that may be used to transfer funds to another person via any electronic device. The term “system”, as used herein, means, but is not limited to software or hardware component. The system may be stored on addressable storage medium, processors, hard drives or accessible memory. The system may include, processes, functions, attributes, procedures, subroutines, segments of program code, drivers, modules, firmware, computer programs, source code, micro code, circuitry, data, databases, data structures, tables, arrays and variables. The term “transferor” as used herein, means, but is not limited to any person or entity. The term “transferee” as used herein, means, but is not limited to any person or entity.

As illustrated in FIG. 2, the Universal Financial Transaction System (UFTS) 100 communicates with transferor's electronic device 400 and transferee's electronic device 500. The transferor's electronic device 400 and transferee's electronic device 500 contains an interface application which allows communication with the UFTS and communication with each other. FIG. 2 also includes numbered steps, signified by numbers in the arrows that illustrate the order of information flow in completing a typical financial transaction.

Step 1 of FIG. 2, the transferor's electronic device 400 sends a request to UFTS 100 approving a transfer of credits from the transferor's account to the transferee's account. In one embodiment, the transferor's mobile phone, PDA or pocket computer 400 sends a wireless request to the UFTS 100 authorizing and approving the transfer of credits from the transferor's account on the UFTS 100 to the transferee's account on the UFTS 100.

Step 2 in FIG. 2, which concurs during the time it is required to approve and process a typical financial transaction in step 1 in FIG. 2, the UFTS 100 transmits advertisement, coupons or marketing material 600 to the transferor's electronic device 400, then at the completion of the financial transaction in step 1 of FIG. 2, the UFTS 100 send a notice to the transferor's electronic device 400 verifying the completion of the financial transaction. In an one advantageous embodiment, the UFTS 100 electronically transmits advertisement, coupons or marketing material 600 to the transferor's mobile phone, PDA, pocket computer or personal computer for audio and/or visual viewing of cached, streaming video, SMS images and sounds, or MMS images and sounds. Then during the time it takes to approve and process the transfer of credits from the transferor's account to the transferee's account on the UFTS 100, UFTS sends a notice verifying the completion of the financial transaction to the transferor's mobile device, PDA, pocket computer or personal computer.

Step 2A in FIG. 2, the advertiser electronically sends advertisements, coupons and/or marketing material to the UFTS 100 and the UFTS 100 charges the advertiser a fee for each advertisement, coupon or marketing material 600 sent to the transferor s electronic device 400.

Step 3 in FIG. 2, the UFTS 100 sends a verification notice to the transferee's electronic device 500 upon completion of the financial transaction described in step 1 in FIG. 2. In one embodiment, the UFTS 100 sends a notice verifying that the financial transaction, the financial transfer of credit from transferor's account to the transferee's account on the UFTS 100, was approved and completed, to the transferee's mobile device, PDA, pocket computer and/or computer 500.

Step 4 in FIG. 2, the transferee's electronic device 500 sends acknowledgment notice to the transferee's account reflecting the deposit of credits from the transferor's account. In one embodiment, the transferee's mobile phone, PDA, pocket computer and/or personal computer 500 electronically or wireless sends to the transferor's mobile phone, PDA, pocket computer and/or personal computer 400 an acknowledgment notice describing the transfer of credits from the transferor's account on the UFTS 100 to the transferee's account on the UFTS 100.

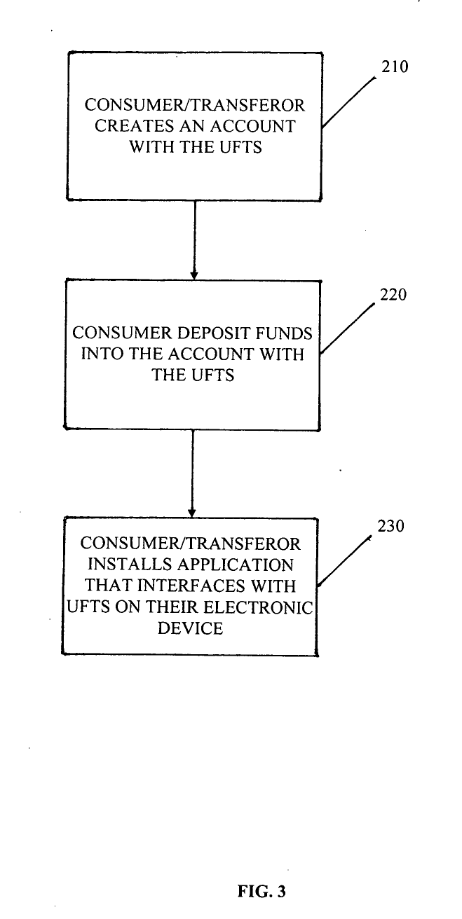

FIG. 3 is a flow diagram illustrating an exemplary process of a consumer or transferor creating account with the Universal Financial Transaction System and funding that account and then installing the application that interfaces with the UFTS on their electronic device. The consumer or transferor used herein, means, the end user or any user of the UFTS. In block 210 the consumer or transferor creates a secure account with the UFTS system. The account is protected through the creation of user identification and personal identification number and/or personal password. This account can account can be created online through the use of the UFTS or through the completion of written application from UFTS or through the completion of a telephone application with the UFTS.

In block 220, the consumer or transferor deposit funds into the secure account held with the UFTS. The consumer, transferor or user of the UFTS, deposits funds into their account via credit card, debit card, check, cash or online banking. These funds are converted in the UFTS universal credits for any transaction.

In block 230, the consumer, transferor, or user UFTS, installs an application that interfaces with the UFTS on their electronic device, for example, mobile phone, PDA, pocket computer or personal computer. The application is encrypted software which only interfaces with the UFTS upon the submittal of the accurate user identity and password and/or personal identification number. Application does not store any such information such as the user identity, password, personal identification number or account information on the user's electronic device.

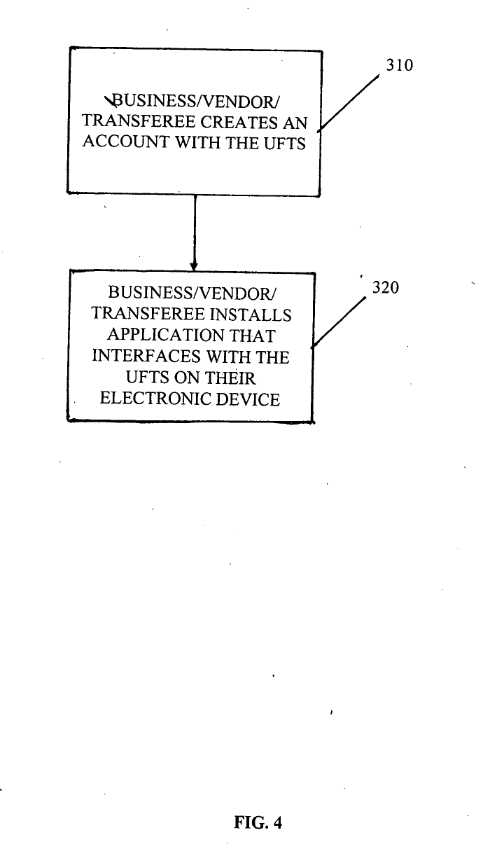

FIG. 4 is a flow diagram illustrating an exemplary process of business, vendor or transferee creating an account with the Universal Financial Transaction System and then installing the application that interfaces with the UFTS on their electronic device.

In block 310, the business, vendor, transferee and any online merchant, business, vendor or transferee creates a secure account with the UFTS system. The account is protected through the creation of user identification and personal identification number and/or personal password. This account can account can be created online through the use of the UFTS or through the completion of written application from the UFTS or through the completion of a telephone application with the UFTS.

In block 320, the business, vendor, transferee and any online merchant, business, vendor or transferee installs an application that interfaces with the UFTS on their electronic device, for example, mobile phone, PDA, pocket computer, personal computer, point of sale system and electronic cash register. The application is encrypted software which only interfaces with the UFTS upon the submittal of the accurate user identity and password and/or personal identification number. Application does not store any such information such as the user identity, password, personal identification number or account information on the user's electronic device.

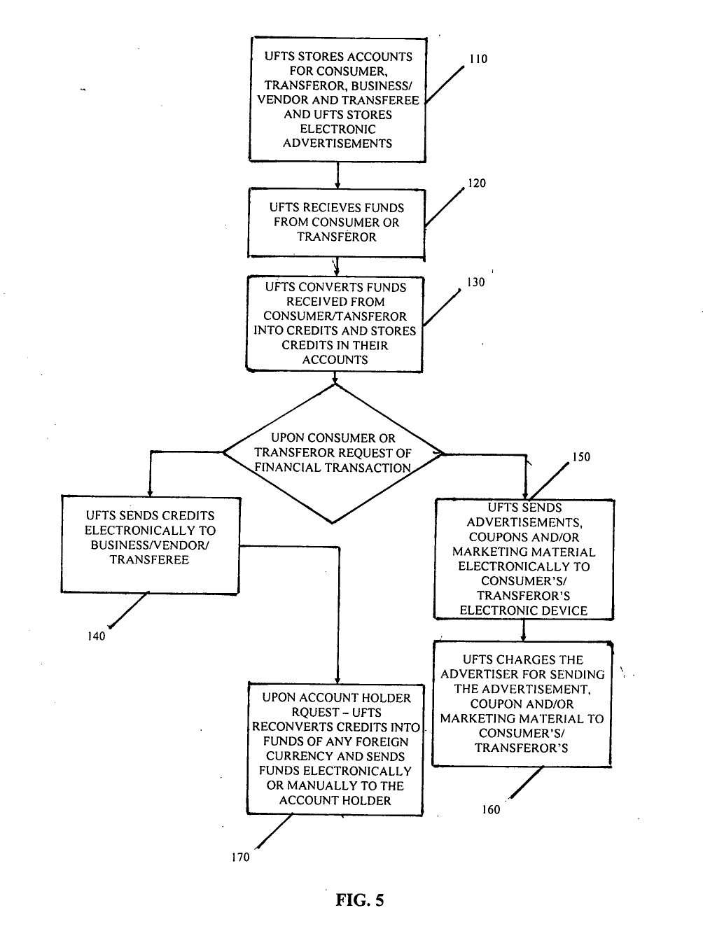

FIG. 5 is a flow diagram illustrating an exemplary process of Universal Financial Transaction System performing a typical financial transaction.

In block 110, the Universal Financial Transaction System (UFTS) stores the account information of any user of the UFTS, for example the consumer, transferor, business, vendor, merchant and transferee, on an encrypted system that provides the highest level of security. The UFTS stores electronic advertisement, coupons and marketing material received from advertiser.

In block 120, the UFTS receives funds from the consumer, transferor or end user to be held in the account that they have with UFTS.

In block 130, the UFTS converts the funds received from the consumer, transferor, or end user into UFTS's universal credits. These credits are stored in the account held by these individuals or entities.

In block 140, the UFTS upon the request of consumer or transferor or user performs a typical financial transaction such as purchase of services or goods by sending a pre-determined amount of credits to a business or vendor, or a financial transfer of credits to another user account on the UFTS.

In block 150, the UFTS sends advertisements electronically to the consumer's or transferor's electronic device such a mobile phone, PDA, personal computer or pocket computer. The advertisement can be cached, video and audio streamlined, SMS, MMS to the consumer or transferor's electronic device.

In block 160, the UFTS charges the advertiser a fee each time they transmit an advertisement to a user's electronic device.

In block 170, the UFTS reconverts credits held in the account holder account into any national or foreign currency and allows these funds to be sent electronically or manually to the account holder or to the account holder's financial institution.

What is claimed is:

1. A method for completing a financial transaction compromising:
a consumer having an electronic device configured with an encrypted software which allows communication with the Universal Financial Transaction System (UFTS) and the business's electronic device;
a business having an electronic device configured with an encrypted software which allows communication with the UFTS and the consumer's electronic device;
a UFTS allowing the electronic payment of good and services by the consumer from the business and the means to communicate advertisement to the consumer during transaction communication;
an advertiser means for transmitting advertisement, coupons and marketing media through the UFTS;
a UFTS allowing the conversion of credits in the account into any type of currency.

2. The method of claim 1, wherein the consumer comprises a person or entity that is a user of the consumer's electronic device.

3. The method of claim 1, wherein the business is selected from a group comprising a retail business, online business, vendor, merchant and service provider.

4. The method of claim 1, wherein the consumer's electronic device is selected from a group comprising a mobile phone, a personal digital assistant and a portable computer.

5. The method of claim 1, wherein the business's electronic device is selected from a group comprising an electronic cash register, point of sale device, financial transaction device, and computer.

6. The method of claim 1, wherein the encrypted software is a secure application installed on the consumer's and business's electronic device which allows the electronic devices to interface with UFTS and each other.

7. The method of claim 1, wherein the act of making electronic payment comprises:
business's electronic device sending the product information and price and the business's deposit account information to the consumer's electronic device electronically;
consumer's electronic device receiving the product information and price and the business's deposit account information;
consumer using their user identification and password to login into the UFTS by means of the encrypted software on their electronic device;
consumer approving the payment and waiting for the completion of the transaction;
UFTS performing the electronic payment and simultaneously electronically transmits advertisement to the consumer's electronic device for viewing during the financial transaction time;
UFTS charges the advertiser a fee for each advertisement media transmitted.

8. The method of claim 7, wherein the act of transmitting comprises the use of Wi-Fi, Bluetooth and wireless internet.

9. A method for completing a financial transaction compromising:
a transferor having an electronic device configured with an encrypted software which allows communication with the Universal Financial Transaction System (UFTS) and the transferee's electronic device;
a transferee having an electronic device configured with an encrypted software which allows communication with the UFTS and the transferor's electronic device;
the UFTS allowing the financial transfer of credits in the transferor's UFTS account to the transferee's UFTS account and the means to communicate advertisement to the transferor during the transfer time;
an advertiser means for transmitting advertisement, coupons and marketing media through the UFTS;
the UFTS allowing the conversion of credits in the transferee's UFTS account into any type of currency.

10. The method of claim 9, wherein the transferor comprises person or entity that is a user of the transferor's electronic device.

11. The method of claim 9, wherein the transferee comprises a person or entity that is a user of the transferee's electronic device.

12. The method of claim 9, wherein the transferor's electronic device is selected from a comprising a mobile phone, a personal digital assistant, a portable computer and personal computer.

13. The method of claim 9, wherein the transferee's electronic device is selected from a group comprising a mobile phone, a personal digital assistant, a portable computer and personal computer.

14. The method of claim 9, wherein the encrypted software is a secure application installed on the transferor's and transferee's electronic device which allows the electronic devices to interface with UFTS and each other.

15. The method of claim 9, wherein the act of making financial transfer comprises:
transferor's using their user identification and password to login into the UFTS by means of the encrypted software on their electronic device;
transferor approving a financial transfer of credits from their UFTS account to the transferee's UFTS account and waiting for the completion of the financial transaction;
UFTS performing the financial transfer and simultaneously transmitting advertisement to the transferor's electronic device for viewing during the financial transfer time;
UFTS charges the advertiser a fee for each advertisement media transmitted.

16. The method of claim 15, wherein the act of transmitting comprises the use of Wi-Fi, Bluetooth and wireless internet.

17. A method for creating account with the UFTS comprising:
a person and/or entity creating account with the UFTS thereby becoming a account holder;
an account holder having established a secure user identification and password to login into their UFTS's account;
an account holder funding their UFTS account with any type of currency;
the UFTS converting the currency into UFTS credits;
an account holder installing encrypted software on their electronic device.

18. The method of claim 17, wherein the person comprises consumer and transferor.

19. The method of claim 17, wherein the entity comprises a retail business, online business, vendor and merchant.

20. The method of claim 17, wherein the password comprises a personal identification number.

21. The method of claim 17, wherein the UFTS account is not funded by the account holder.

22. The method of claim 17, wherein the act of creating UFTS account comprises completion of application online, by phone and/or in writing.

23. The method of claim 17, wherein the act of the account holder funding their UFTS account with any type of currency compromises manual deposits into the account by means of cash and checks and electronic deposits into the account by the means of credit card, debit card and financial institution.

24. The method claim 17, wherein any type of currency comprises United States currency and any foreign international recognized currency.

25. The method of claim 17, wherein the act of installing the encrypted software on the electronic device comprises downloading the software onto the electronic device by means of the interne, CD, hard drive and hard disk.

26. The method of claim 17 wherein encrypted software comprises an application that allows the interface with UFTS and other electronic devices; and application does not store any account holder information on the electronic device.

27. A system and method for completing financial transaction compromising:
the UFTS store accounts for a person and entity;
the UFTS stores advertisement media, marking media and coupons for the advertiser;
the UFTS receives currency of any type from account holder and converts currency into UFTS credits;
the UFTS make electronic payments through the means of UFTS credits to persons and/or entity;
the UFTS make financial transfer of credits from one account to another account on the UFTS
the UFTS electronically sends advertisement media, coupons and marketing media to the person and entity;
the UFTS charges the advertiser a fee for each transmittal of the advertisement to an electronic device;
the UFTS converts UFTS credits into United States and/or any type of foreign currency.
